(19) United States
(12) Patent Application Publication
(10) Pub. No.: US 2015/0254404 A1
(43) Pub. Date: Sep. 10, 2015

(54) AUTOMATIC STOCK AND REQUISITION ADMINISTRATION SYSTEM AND METHOD FOR MEDICAL AND NURSING APPLICATION

(71) Applicant: R3DSTAR Biomedical Corp., Taipei City (TW)

(72) Inventors: Shih-Hao Ko, Taipei City (TW); Yun-Jung Lin, Taipei City (TW); Kuan-Hsin Chen, Taipei City (TW); Hsuan-Cheng Lin, Taipei City (TW); Chun-Yu Chen, Taipei City (TW); Paul Makena Kapu, Nolensville, TN (US)

(73) Assignee: R3DSTAR Biomedical Corp., Taipei City (TW)

(21) Appl. No.: 14/198,044

(22) Filed: Mar. 5, 2014

(51) Int. Cl. G06F 19/00; G06K 7/10

(52) U.S. Cl. CPC G06F 19/327; G06K 7/10366

(57) ABSTRACT

The present invention discloses an automatic stock and requisition administration system and method for medical and nursing application. The system comprises a cloud platform, at least one intelligent handheld device, and at least one automatic material supply machine. The automatic material supply machine links to the cloud platform through a network. The cloud platform generates requisition forms automatically according to nursing requirements or physician orders and provides the requisition forms for the automatic material supply machine and the intelligent handheld devices according to nursing schedules in user information. The users confirmed by a user recognition process can fast pick required materials from the automatic material supply machine in correct types and quantities. The information of the picked materials is transmitted to the cloud platform, and the cloud platform undertakes statistics and administration of materials. Thus can be improved inefficient medical material administration resulting from overstocking or undersupplying medical materials.

### BACKGROUND OF THE INVENTION

1. Field of the Invention

The present invention relates to an automatic stock and requisition administration system and method for medical and nursing application, particularly to a system and method, which uses bidirectional information transmission of an automatic material supply machine, an intelligent handheld device and a cloud platform to administrate requisition of medical materials, whereby to correctly pick medical materials and precisely administrate the quantities, types, and expiration dates of medical materials, wherefore medical personnel and material administrators are greatly convenienced.

2. Description of the Related Art

With persistent advance of science and technology, medical and healthcare technology is growing sophisticated, and the developed countries have become aged societies. Hence, lifestyle diseases and senile diseases have become important subjects globally.

The medical personnel usually have to pick materials from different warehouses for patients or elders of medical centers, regional hospitals, clinics, homecare service according to the requirements of the patients or the orders of physicians. Such a mode not only inconvenience medical personnel considerably but also consumes much time of warehouse administrators. The medical materials are likely to overstore or undersupply because the quantities, types and dates of material requisitions and the material stocks in hand are hard to precisely administrate. The medical materials that are unused for a long time will denature or expire finally, which may cause medical errors, endanger patients, or incur medical disputes. The warehouse administrators may inventory and replenish the stock to solve the abovementioned problems. However, the types of medical materials are numerous, and the inventory and replenishment thereof is laborious, time-consuming and inefficient. Because it is difficult for administrators to precisely grasp the quantities and types of the medical materials picked by the medical personnel or very carefully verify the authorizations of material requisitions, they are hard to control quality of medicine and correctness of material usage. Therefore, how to improve administration of medical materials has become an important problem in promoting the overall medical quality.

Accordingly, the present invention proposes an automatic stock and requisition administration system and method for medical and nursing application to overcome the abovementioned problems.

### SUMMARY OF THE INVENTION

The primary objective of the present invention to provide an automatic stock and requisition administration system and method for medical and nursing application, which can automatically generate and edit requisition forms according to nursing requirements, physician orders, and nursing schedules of caregivers, whereby to solve the problems that the caregivers experience inconvenience in picking medical materials and that medical materials are likely to overstore or undersupply, and whereby to effectively administrate the stocks, types and expiration dates of medical materials and precisely grasp the detailed data of the medical materials picked by caregivers, wherefore medical materials can be administrated efficiently.

To achieve the abovementioned objective, the present invention proposes an automatic stock and requisition administration system for medical and nursing application, which comprises a cloud platform, at least one intelligent handheld device and at least one automatic material supply machine. The cloud platform administrates a plurality of pieces of material information and a plurality of pieces of user information and provides at least one requisition form and the related information of the user going to pick materials. The intelligent handheld device links to the cloud platform through a network to receive a requisition form, whereby the caregiver can confirm the information of material requisition or edit the information of material requisition according to requirement. The automatic material supply machine links to the cloud platform through a network. Each automatic material supply machine includes a material storage, a material discharge opening, a central control module, a user recognition unit and a first RFID (Radio Frequency IDentification) recognition unit. The central control module is electrically connected with the user recognition unit and the first RFID recognition unit. The material storage stores a plurality of medical materials each having a label. The first RFID recognition unit is arranged in the material discharge opening. The user recognition unit identifies the user information of at least one user. The central control module transfers at least one medical material listed in the requisition form to the material discharge opening for the user whose identity matches the requisition form. The first RFID recognition unit reads the material information of the materials picked by the user and transmits the material information to the cloud platform. Then, the cloud platform records the material information of the picked material. Besides, a second RFID recognition unit is used to read the information of the materials stored in the material storage and transmit the material information to the cloud platform. Then, the cloud platform undertakes statistics and administration of the materials stored in the material storage. Via the bidirectional information transmission of the automatic material supply machine, the intelligent handheld devices and the cloud platform, the administrators can effectively administrate medical materials, such as drugs, medical consumables, healthcare foods, nasogastric tube nutritions, and ordinary foods and provide caregivers with required materials precisely Therefore, the present invention can greatly convenience caregivers and effectively promote the nursing quality of patients and elders.

The present invention also proposes an automatic stock and requisition administration method for medical and nursing application, which comprises steps: linking an automatic material supply machine to a cloud platform after the material supply machine is turned on; the automatic material supply machine receiving from the cloud platform at least one requisition form and the user information of the user going to pick materials; using at least one intelligent handheld device to link to and log in the cloud platform through a network and receive a requisition form; identifying whether the user intending to pick at least one material matches the user information; if the user does not match the user information, the system waiting for the next cycle of identifying users; if the user matches the user information, the user picking at least one material listed in the requisition form from the automatic material supply machine; the automatic material supply machine reading the material information of the picked materials and transmitting the material information of picked materials to the cloud platform; and the cloud platform recording the material information of picked materials and undertaking statistics and administration of the materials stored in the material storage.

Below, the present invention is described with embodiments to make easily understood the objectives, technical contents, characteristics and accomplishments of the present invention.

### BRIEF DESCRIPTION OF THE DRAWINGS

FIG. 1 is a diagram schematically showing an automatic stock and requisition administration system for medical and nursing application according to one embodiment of the present invention;

FIG. 2 is a block diagram schematically showing the architecture of an automatic stock and requisition administration system for medical and nursing application according to one embodiment of the present invention;

FIG. 3 is a diagram schematically showing an automatic material supply machine according to one embodiment of the present invention;

FIG. 4 shows a flowchart of an automatic stock and requisition administration method for medical and nursing application according to one embodiment of the present invention;

FIG. 5 shows a flowchart of an initiation process according to one embodiment of the present invention;

FIG. 6A and FIG. 6B show a flowchart of an additional process according to one embodiment of the present invention.

### DETAILED DESCRIPTION OF THE INVENTION

Nowadays, intelligent handheld devices, such as smart phones or tablet computers, are very popular, and almost everyone has his own intelligent handheld device. Further, the application of multimedia has been diversified. The present invention is addressed to administration of medical materials, such as drugs, medical consumables, healthcare foods, nasogastric tube nutritions, and ordinary foods. The present invention promotes convenience of material administration and correctness of material requisition, using the multimedia function of intelligent handheld devices and an administration system containing a cloud platform and an automatic material supply machine. Thereby, the present invention brings much convenience to the field of medicine. The present invention, it is not necessarily an intelligent handheld device that the user uses to browse material information and undertake identity verification, however.

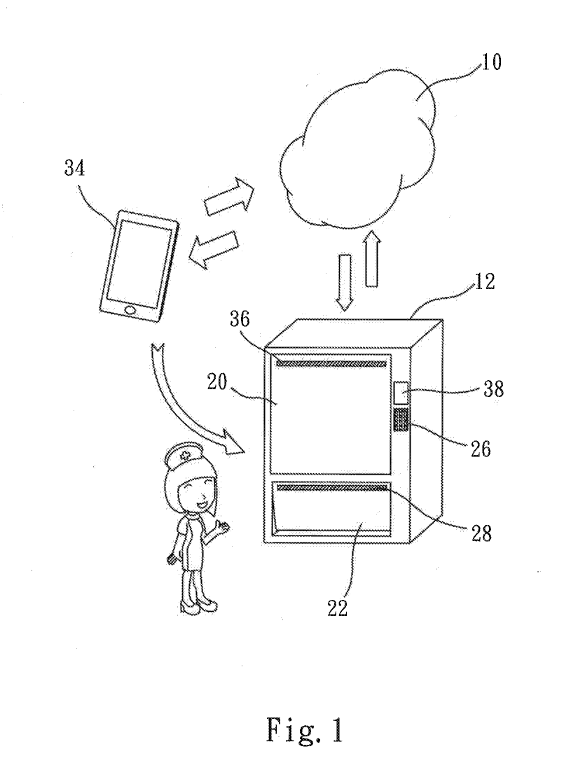

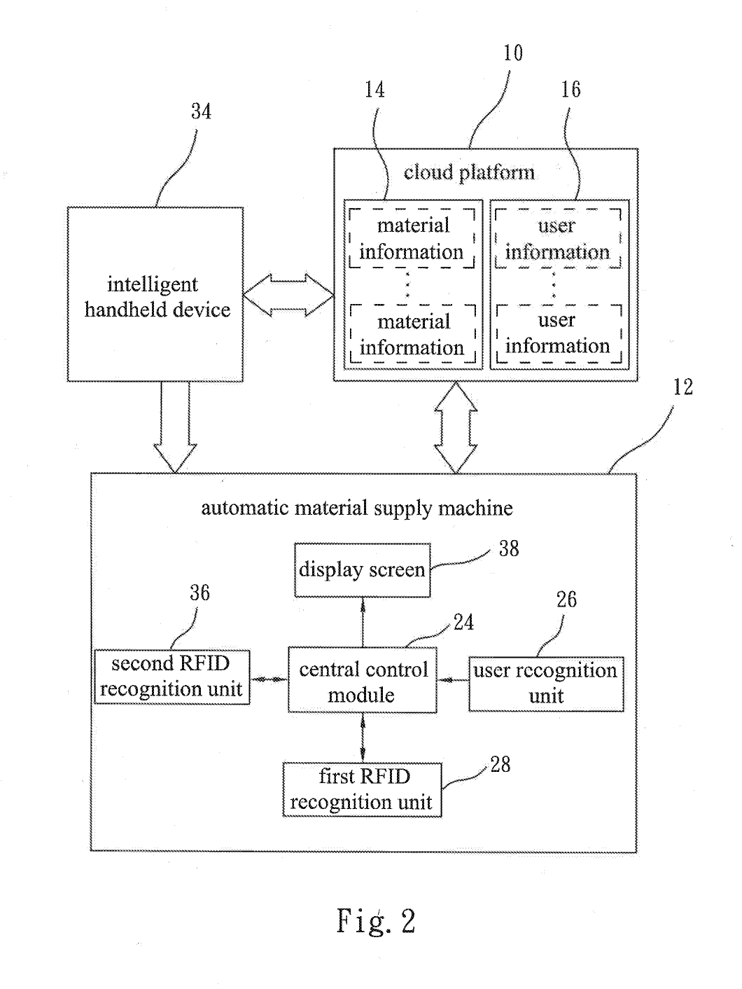

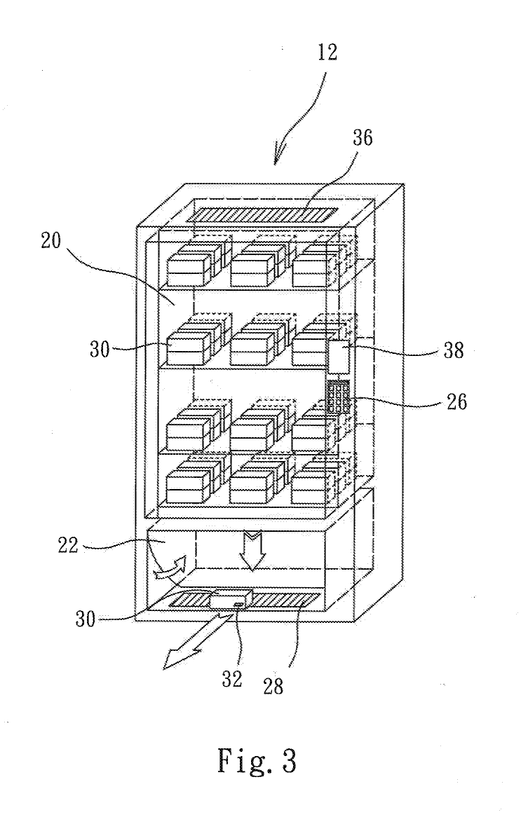

Refer to FIGS. 1-3. FIG. 1 is a diagram schematically showing an automatic stock and requisition administration system for medical and nursing application according to one embodiment of the present invention. FIG. 2 is a block diagram schematically showing the architecture of an automatic stock and requisition administration system for medical and nursing application according to one embodiment of the present invention. FIG. 3 is a diagram schematically showing an automatic material supply machine according to one embodiment of the present invention. The automatic stock and requisition administration system for medical and nursing application of the present invention comprises a cloud platform 10, at least one intelligent handheld device 34 and at least one automatic material supply machine 12. The cloud platform 10 administrates a plurality of pieces of material information 14 and a plurality of pieces of user information 16 and provides at least one requisition form and the related information of the user going to pick materials. The requisition forms are generated according to requirements of nursing, orders of physicians, and duty schedules of caregivers. The cloud platform 10 provides requisition forms for caregivers according to the duty schedules thereof. The requisition form further includes the information of at least one carereceiver and the material information 14 corresponding to the carereceivers. Therefore, the caregiver can clear learn which medical material is required by a specified carereceiver and verify the correctness of the materials listed in the requisition forms.

The intelligent handheld device 34 links to and logs in the cloud platform 10 through a network to receive requisition forms. The intelligent handheld device 34 is a device having multimedia function, such as a smart phone, a tablet computer or a notebook computer. The user uses the intelligent handheld device 34 to input an identification data, such as an account number or a password, to the cloud platform 10 so as to log in the cloud platform 10. The cloud platform 10 verifies whether the input identification data matches the user information of one of the qualified users, such as the personal data and the duty schedule. If the input identification data matches the user information of one of the qualified users, the cloud platform 10 transmits the requisition forms to the intelligent handheld device 34. After the user transmits a confirmation message to the cloud platform 10, the cloud platform 10 transmits a PIN (Personal Identification Number) code to the intelligent handheld device 34. Latter, the user inputs the PIN code to the cloud platform 10 for picking materials listed in the requisition forms.

The automatic material supply machine 12 links to the cloud platform 10 through a network. Each automatic material supply machine 12 includes a material storage 20, a material discharge opening 22, a central control module 24, a user recognition unit 26 and a first RFID (Radio Frequency IDentification) recognition unit 28. The central control module 24 is electrically connected with the user recognition unit 26 and the first RFID recognition unit 28. The material storage 20 stores a plurality of medical materials 30 each having a label 32. The label 32 contains material information, such as types, expiration dates, volumes, applications, and suppliers. The automatic material supply machine 12 links to the cloud platform 10 through a network. Then, the cloud platform 10 uses HTTPS (Hypertext Transfer Protocol Secure) or FTP (File Transfer Protocol) to transmit the requisition forms and the user information of the user going to pick materials to the automatic material supply machine 12 in a POST method. While the user (i.e. the caregiver) intends to pick materials, he goes to the automatic material supply machine 12 for identity verification. The identity verification is undertaken by the user recognition unit 26. The user recognition unit 26 is a QR. (Quick Response) code identifier, a keyboard module, an RFID reader, a near-field Wireless communicator, a fingerprint recognition device, an iris recognition device, a face recognition device, a voiceprint recognition device, a colored picture recognition device, or a combination thereof. According the requisition form of the qualified user, the central control module 24 transports from material storage 20 at least one material 30 listed in the requisition form to the material discharge opening 22. At this time, the first RFID recognition unit 28, which is arranged in the material discharge opening 22, immediately reads the material information of the material 30. In one embodiment, the first RFID recognition unit 28 is an RFID reader reading the label 32 on the material 30 to obtain material information. The sensing range of the first RFID recognition unit 28 is 2-5 cm. Then, the central control module 24 feeds back the information of the picked material to the cloud platform 10, and the cloud platform 10 records the information of picked materials precisely.

The automatic material supply machine 12 further comprises a second RFID recognition unit 36, which is arranged in the material storage 20 and electrically connected with the central control module 24. The second RFID recognition unit 36 reads the information of all types of materials 30 stored in the material storage 20 and transmits the information to the cloud platform 10. Then, the cloud platform 10 undertakes statistics and administration of the materials 30. The first RFID recognition unit 28 and the second RFID recognition unit 36 are respectively arranged at different locations and separated from each other by a given distance. Therefore, the first RFID recognition unit 28 and the second RFID recognition unit 36 would not read the information of an identical material 30 repeatedly.

In addition to directly verifying the identity of the user in the automatic material supply machine 12 in the abovementioned ways, the user recognition unit 26 may also verify the identity of the user, using a QR code identifier to verify the OR code presented by the intelligent handheld device 34 of the user. Once the identity of the user is confirmed, the user can pick the materials 30 listed in the requisition forms. In one embodiment, the user links his intelligent handheld device 34 to link to and log in the cloud platform 10 through a network; once the cloud platform 10 determines that the user using the intelligent handheld device 34 to log in the cloud platform 10 is one of qualified users, the cloud platform 10 transmits requisition forms to the intelligent handheld device 34. Then, the user can use the intelligent handheld device 34 to check whether the requisition forms are correct and directly edit the information of the materials 30 in the intelligent handheld device 34, such as adding, deleting or modifying the information of the materials 30. Then, the user transmits the amended requisition forms back to the cloud platform 30, and the cloud platform 10 evaluates whether the materials 20 listed in the amended requisition forms are allowed to be picked by the user. If the user is allowed to pick these materials 30, the cloud platform 10 generates new requisition forms and the related information of the user and presents the new requisition forms on the intelligent handheld device 34 of the user. Next, the user uses his intelligent handheld device 34 to transmit a material requisition message to the cloud platform 10, and the cloud platform 10 transmits a personal authentication code or a QR code to the intelligent handheld device 34. At the same time, the cloud platform 10 transmits a message containing the personal authentication code or QR code to the automatic material supply machine 12. Once the automatic material supply machine 12 confirms the personal authentication code or QR code, the automatic material supply machine 12 transports the materials 30 listed in the requisition forms from the material storage 20 to the material discharge opening 22. Then, the user can pick the materials 30. The information of all the picked materials 30 is read by the first RFID recognition unit 28 and transmitted by the central control module 24 to the cloud platform 10. Thereby the cloud platform 10 can effectively undertake statistics and administration of the materials and precisely grasp the storage of the materials 30.

The automatic material supply machine 12 further includes a display screen 38 for presenting material stocks, material usage states (such as being transported, understock, being closed, and user information being verified), and results of user recognition. According to the information the automatic material supply machine 12 feeds back to the material storage 20, the cloud platform 10 automatically generates replenishment lists to the related administrators, such as nursing personnel, medical product manufacturers, convenience goods manufacturers, and food manufacturers. Thereby, the administration system of the present invention can guarantee that automatic material supply machine 12 can always supply required materials to the caregivers.

In addition to the Internet, the linkage between the cloud platform 10 and the automatic material supply machine 12 can also be facilitated by WiFi, GSM, LTE, WiMAX, BT, LAN, or Phone line. In one embodiment, the cloud platform 10 further accesses patient information or physiological information to automatically generate material requisition forms whereby the caregivers can pick required materials or replenishment lists whereby the administrators can undertake purchase.

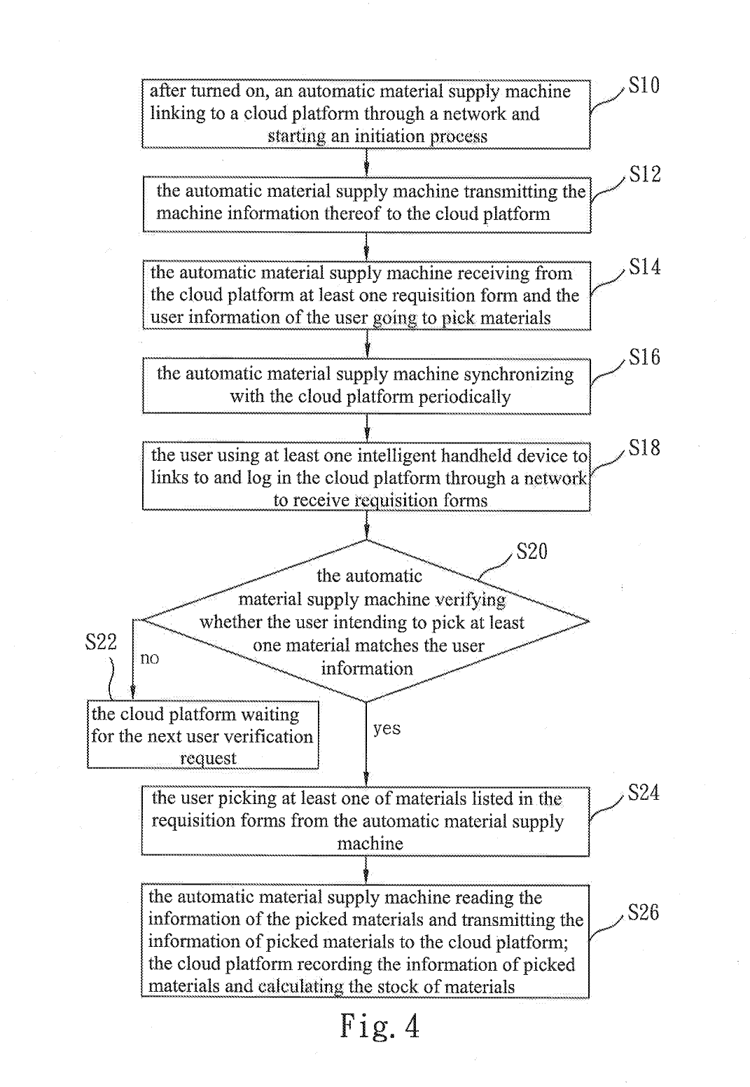

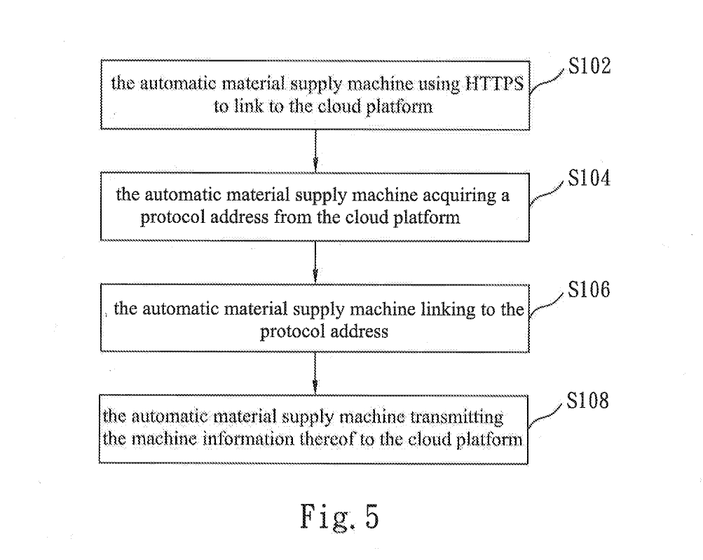

The system of the present invention has been described above. The method of the present invention will be described blow. Refer to FIGS. 2-4. FIG. 4 shows a flowchart of an automatic stock and requisition administration method for medical and nursing application according to one embodiment of the present invention. In Step S10, after an automatic material supply machine 12 is turned on, the automatic material supply machine 12 links to a cloud platform 10 through a network and starts an initiation process. A large medical organization has many automatic material supply machines 12, wherefrom caregivers and medical personnel can pick required materials. Refer to FIG. 5 showing a flowchart of an initiation process undertaken by the system of the present invention. In Step S102, the automatic material supply machine 12 links to the cloud platform 10, using a data transmission protocol, such as HTTPS or FTP. In Step S104, the automatic material supply machine 12 acquires a protocol address from the cloud platform 10. In Step S106, the automatic material supply machine 12 links to the protocol address, whereby a communication link is established. In Step S108, the automatic material supply machine 12 transmits the machine information thereof to the cloud platform 10. The machine information of the automatic material supply machine 12 includes the model number of the automatic material supply machine 12, the stocks of all the materials the automatic material supply machine 12 contains and the material information of the materials, and the positional information of the automatic material supply machine 12. In one embodiment, the automatic material supply machine 12 includes a GPS system (not shown in the drawings). The automatic material supply machines 12 of different medical units have different materials 30 thereinside. Therefore, each automatic material supply machine 12 undertakes an initiation process while turned on so that the cloud platform 10 can simultaneously and efficiently administrate a great number of materials belonging to numerous types, such as drugs including tablet drugs, capsule drugs, powder drugs, injection drugs, ointments, spray drugs, and liquid drugs), anti-cancer agents, target therapy drugs, protein drugs, healthcare foods, nasogastric tube nutritious, foods, medical consumables.

In Step S12, the automatic material supply machine 12 transmits to the cloud platform 10 the machine information of the automatic material supply machine 12, including the model number of the automatic material supply machine 12, the stocks of all the materials the automatic material supply machine 12 contains, and the material information of the materials. In Step S14, the automatic material supply machine 12 receives from the cloud platform 10 at least one requisition form and the related user information of the user going to pick the materials 30, and waits the user for picking the materials 30. Before the user picks the materials 30, the process undertakes Step S16. In Step S16, the automatic material supply machine 12 synchronizes with the cloud platform 10 periodically. In details, the cloud platform 10 examines whether the format of the packet of the information of the automatic material supply machine 12 is correct. If the format of the packet is doubtful or rejected, the packet is regarded as an exception incident. The procession of treating an exception incident will be repeated three times. If the packet still fails to pass examination finally, the cloud platform 10 informs the administrators of the incident in SMS, email, fax, instant messaging (such as Skype or Line). If the format of the packet is correct, the cloud platform 10 evaluates whether to transmit a requirement instruction to the automatic material supply machine 12. If the cloud platform 10 determines that it is unnecessary to transmit a requirement instruction, the synchronization between the cloud platform 10 and the automatic material supply machine 12 is ended,

In Step S18, at least one intelligent handheld device 34 links to and logs in the cloud platform 10 through a network to receive requisition forms, whereby the users (i.e. the caregivers) can browse, check, edit, or confirm the requisition forms. In Step S20, the automatic material supply machine 12 verifies whether the user intending to pick at least one material 30 matches the user information. In one embodiment, the automatic material supply machine 12 uses a user recognition unit 26 to verify the user. In one embodiment, the user uses an intelligent handheld device 34 to present a QR code, and the user recognition unit 26 (such as a QR code reader) reads the information of the user and verifies the identity of the user. In one embodiment, the user uses an intelligent handheld device 34 to link to and log in the cloud platform 10 through a network, and the cloud platform 10 evaluates whether the identity of the user matches the user information of one of the qualified users. After the cloud platform 10 confirms the identity of the user, the user transmits a requisition message to the cloud platform 10. Next, the cloud platform 10 transmits a PIN code to the intelligent handheld device 34. Next, the user inputs the PIN code to the automatic material supply machine 12 and picks the materials 30 listed in the requisition forms. The abovementioned user verification methods are only preferred embodiments of the present invention. The present invention does not particularly limits the method of verifying users. If the cloud platform 10 does not confirm the identity of the user, the process proceeds to Step S22. In Step S22, the cloud platform 10 waits for the next user verification request. If the cloud platform 10 confirms the identity of the user, the process proceeds to Step S24, the user is allowed to pick at least one of materials listed in the requisition forms from the automatic material supply machine 12. Next, the process proceeds to Step S26. In Step S26, the automatic material supply machine 12 reads the information of the materials 30 picked by the user and transmits the information of picked materials the cloud platform 10; then the cloud platform 10 records the information of picked materials 30 and calculates the stock of materials 30 in the material storage 20. In one embodiment, a second RFID recognition unit 36 arranged in the material storage 20 reads the information of all the materials 30 stored in the material storage 20 and transmits the information to the cloud platform 10; then, the cloud platform 10 undertakes statistics and administration of the materials 30. Therefore, the present invention can effectively administrate medical materials via recording the information of picked materials and the information of the stocked materials.

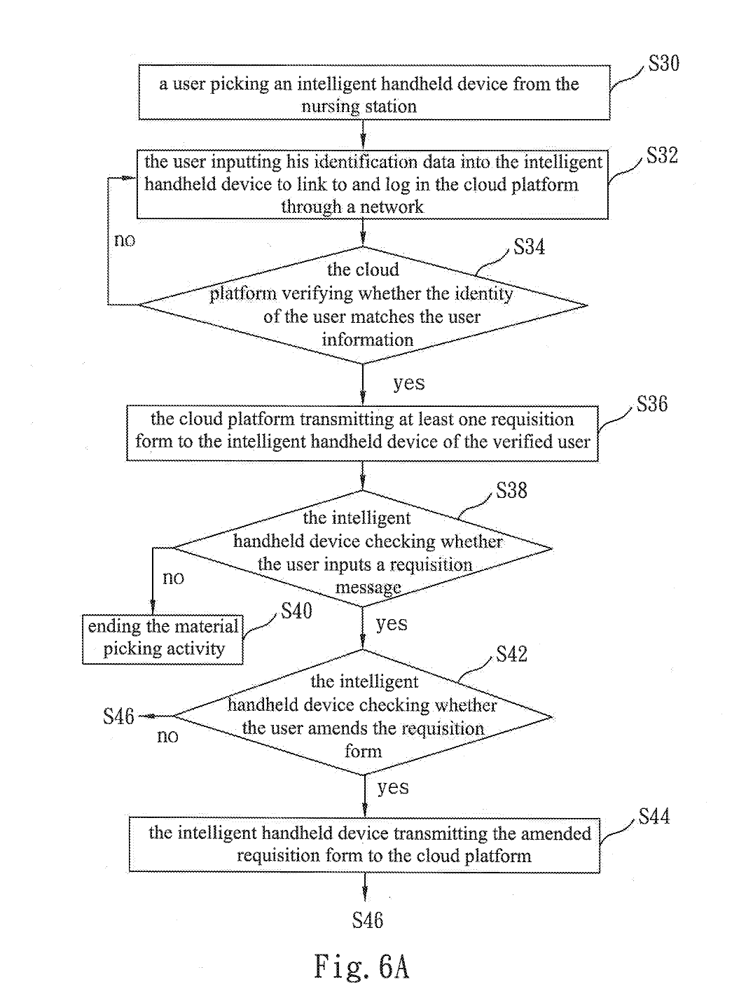

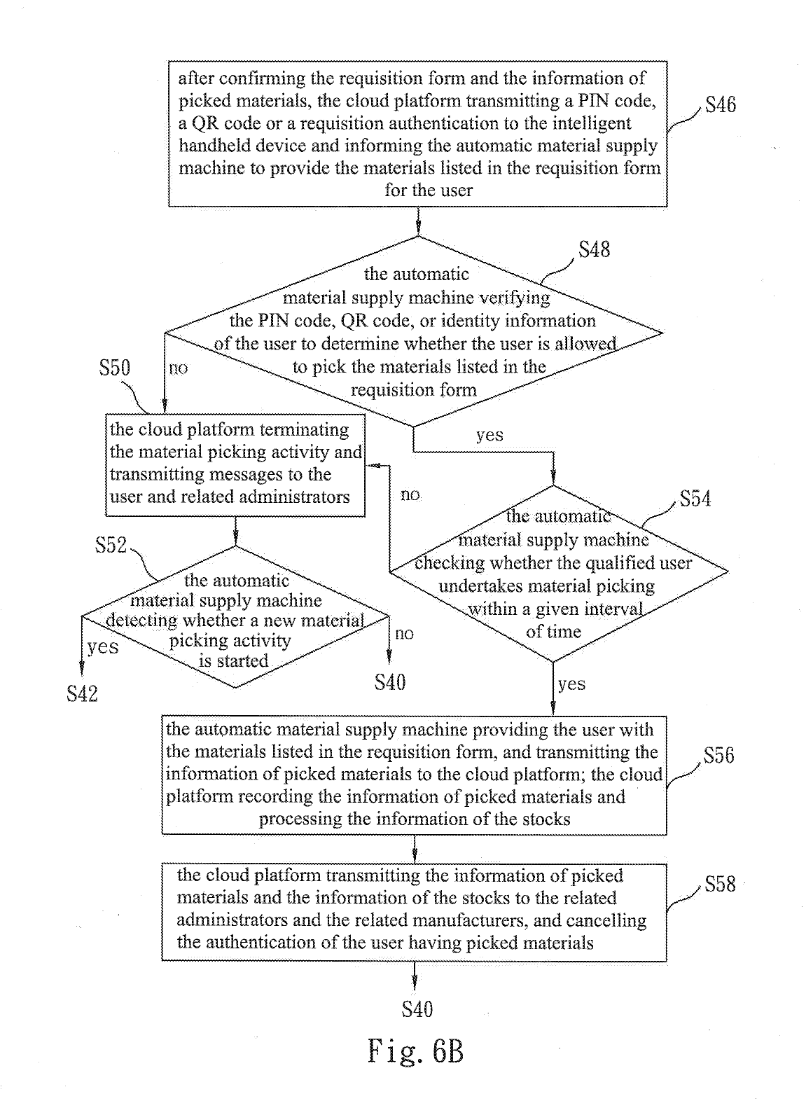

In order to promote the accuracy of material picking, the present invention further undertakes an additional process. Refer to FIG. 2, FIG. 6A and FIG. 6B. FIG. 6A and FIG. 6B show the flowchart of the additional process according to one embodiment of the present invention. In Step S30, a user (a medical staff or caregiver, who has registered his shift in the system) picks an intelligent handheld device 34 from the nursing unit. In Step S32, the user inputs his identification data (such as his account number or password) into the intelligent handheld device 34 and links the intelligent handheld device 34 to the cloud platform 10 through a network. In Step S34, the cloud platform 10 verifies whether the identity of the user logging in through the intelligent handheld device 34 matches the user information of one of qualified users. If the cloud platform 10 does not confirm the identity of the user, the process returns to Step S32. Thus, the user has to log in the cloud platform 10 once again. If the cloud platform 10 confirms the identity of the user, the process proceeds to Step S36. In Step S36, the cloud platform 10 transmits at least one requisition form to the verified intelligent handheld device 34. Thereby, the user can browse the information in the requisition forms. A medical staff or caregiver may only attend a single carereceiver or attend a plurality carereceivers simultaneously. If the user only attends a single carereceiver, the cloud platform 10 transmits to the user only a piece of requisition form, which contains the information of the carereceiver and the information of the materials required by the carereceiver. If the user attends a plurality of carereceivers, the cloud platform 10 transmits to the user several pieces of requisition forms, which respectively contain the information of the carereceivers and the information of the materials required by the carereceivers. Next, the process proceeds to Step S38. In Step S38, the intelligent handheld device 34 checks whether the user inputs a requisition message. If the user does not input a requisition message, the process proceeds to Step S40 and ends. If the user inputs a requisition message, the process proceeds to Step S42. In Step S42, the intelligent handheld device 34 checks whether the user amends the requisition forms. If the user amends the requisition forms, the process proceeds to Step S44. In Step S44, the intelligent handheld device 34 transmits the amended requisition forms to the cloud platform 10. Then, the process proceeds to Step S46. If the user does not amend the requisition forms, the process directly proceeds to Step S46. In Step S46, after the cloud platform 10 confirms the requisition forms, the cloud platform 10 transmits a personal authentication code, a requisition authentication, or a QR code to the intelligent handheld device 34 and informs the automatic material supply machine 12 to provide the materials 30 listed in the requisition forms for the user, who has the personal authentication or requisition authentication or matches the QR code. In one embodiment, the cloud platform 10 checks whether the materials listed in the amended requisition forms match the regulations. If the materials listed in the amended requisition forms match the regulations, the cloud platform 10 transmits a personal authentication code, a requisition authentication, or a QR code to the intelligent handheld device 34 where the requisition forms are amended. According to the information transmitted between the cloud platform 10 and the intelligent handheld device 34, it is learned whether the user is simply to enquire the requisition forms of the carereceivers or is to enquire the requisition forms and pick the materials simultaneously.

Next, the process proceeds to Step S48. In Step S48, the automatic material supply machine 12 verifies the PIN code, QR code, or identity information of the user to determine whether the user is allowed to pick the materials listed in the requisition forms. In details, the automatic material supply machine 12 is equipped with a QR code recognition device, a keyboard module, an RFID reader, a near-field wireless communicator, a fingerprint recognition device, an iris recognition device, a face recognition device, a voiceprint recognition device, a colored pattern recognition device, or a multifunctional recognition device integrating the abovementioned devices. The user uses the keyboard module to input the PIN code (downloaded from the cloud platform 10) into the automatic material supply machine 12 for verification, or shows the QR code of the intelligent handheld device 34 to the QR code recognition device of the automatic material supply machine 12 for verification, or directly uses the RFID reader, fingerprint recognition device, iris recognition device, face recognition device, or voiceprint recognition device of the automatic material supply machine 12 to verify the identity of the user, who has been confirmed and authenticated by the cloud platform 10 beforehand. If the identity verification fails repeatedly three times, the process proceeds to Step S50. In Step S50, the automatic material supply machine 12 transmits a message of identity verification failure to the cloud platform 10; then, the cloud platform 10 terminates the material picking activity, cancels the authentication of material picking (such as the PIN code or QR code), and transmits messages to the user and related administrators. Next, the process proceeds to Step S52. In Step S52, the automatic material supply machine 12 detects whether a new material picking activity is started. If a new material picking activity is started, the process returns to Step S42. If no new material picking activity is started, the process returns to Step S40, and the material picking process is ended. Below, Step S48 is further described in detail. While the automatic material supply machine 12 determines that the PIN code or QR code is qualified, the process proceeds to Step S54. In Step S54, the automatic material supply machine 12 checks whether the qualified user undertakes material picking within a given interval of time (such as a time interval of from 3 minutes to 1 hour). If the user does not pick materials within the given interval of time, the process proceeds to Step S50. If the user picks materials within the given interval of time, the process proceeds to Step S56. In Step S56, the automatic material supply machine 12 provides the user with the materials listed in the requisition forms, and transmits the information of picked materials to the cloud platform 10; then, the cloud platform 10 records the information of the picked materials and processes the information of the stocks. Next, the process proceeds to Step S58. In Step S58, the cloud platform 10 transmits the information of picked materials and the information of the stocks to the related administrators and the related manufacturers, and cancels the authentication (such as the PIN code or QR code) of the user having picked materials. Next, the process proceeds to Step S40, and the material picking activity is ended.

In conclusion, the present invention uses bidirectional information transmission of an automatic material supply machine, an intelligent handheld device and a cloud platform to effectively administrate materials and the applications thereof, including drugs, medical consumables, healthcare foods, nasogastric tube nutritions, and ordinary foods. The present invention enables hospitals to administrate medical materials efficiently and facilitates the related users to pick medical materials conveniently. Further, the present invention can prevent hospitals and medical personnel from medical disputes caused by picking incorrect quantities or types of medical materials and exempt the administrators from overstoring or undersupplying medical materials.

The embodiments described above are only to exemplify the present invention but not to limit the scope of the present invention. Any equivalent modification or variation according to the characteristic or spirit of the present invention is to be also included within the scope of the present invention.

What is claimed is:

1. An automatic stock and requisition administration system for medical and nursing application, comprising:
a cloud platform administrating a plurality of pieces of material information and a plurality of pieces of user information, and providing at least one requisition form and information of a user going to pick materials listed in said requisition form;
at least one intelligent handheld device linking to and logging in said cloud platform through a network to receive said requisition form; and
at least one automatic material supply machine linking to said cloud platform through a network and each including a material storage, a material discharge opening, a central control module, a user recognition unit and a first RFID (Radio Frequency Identification) recognition unit, wherein said material storage stores a plurality of materials each having a label; said first RFID recognition unit is arranged in said material discharge opening; said user recognition unit identifies said user information of at least one user; said central control module transfers from said material storage to said material discharge opening at least one material listed in said requisition form for said user confirmed by said user recognition unit; said first RFID recognition unit reads said material information of said material picked by said user and transmits said material information to said cloud platform; said cloud platform records said material information.

2. The automatic stock and requisition administration system for medical and nursing application according to claim 1, wherein said automatic material supply machine links to said cloud platform through a network; a POST method and one of HTTPS (Hypertext Transfer Protocol Secure) and FTP (File Transfer Protocol) are used in bidirectional information transmission between said automatic material supply machine and said cloud platform.

3. The automatic stock and requisition administration system for medical and nursing application according to claim 1, wherein said user recognition unit is a QR (Quick Response) code identifier, a keyboard module, an RFID reader, a near-field wireless communicator, a fingerprint recognition device, an iris recognition device, a face recognition device, a voiceprint recognition device, a colored picture recognition device, or a combination thereof.

4. The automatic stock and requisition administration system for medical and nursing application according to claim 3, wherein said user uses said intelligent handheld device to present a QR code, and said QR code identifier reads said QR code to obtain said user information of said user.

5. The automatic stock and requisition administration system for medical and nursing application according to claim 1, wherein said cloud platform evaluates whether a user using one said intelligent handheld device to log in said cloud platform matches one piece of said user information; if said user matches one piece of said user information, said cloud platform transmits said requisition form to said intelligent handheld device; after receiving a requisition request message from said user, said cloud platform transmits a PIN (Personal Identification Number) code or a QR code to said intelligent handheld device.

6. The automatic stock and requisition administration system for medical and nursing application according to claim 1, wherein said user uses said intelligent handheld device or a computer to transmit a material requirement list to said cloud platform through a network; said cloud platform generates said requisition form and said user information of said user according to said material requirement list.

7. The automatic stock and requisition administration system for medical and nursing application according to claim 1, wherein said user uses said intelligent handheld device or a computer to edit said material information in said requisition form into an amended requisition form and transmit said amended requisition form to said cloud platform; after said cloud platform confirms said amended requisition form, said cloud platform generates a new requisition form and one piece of said user information of said user.

8. The automatic stock and requisition administration system for medical and nursing application according to claim 1, wherein said material information includes information of drugs, medical consumables, healthcare foods, nasogastric tube nutritions, and ordinary foods.

9. The automatic stock and requisition administration system for medical and nursing application according to claim 1, wherein data of said requisition form is generated according to nursing requirements or physician orders; said cloud platform provides said requisition form corresponding to a nursing schedule recorded in said user information of said user.

10. The automatic stock and requisition administration system for medical and nursing application according to claim 1, wherein data of said requisition form includes data of a carereceiver and at least one piece of said material information.

11. The automatic stock and requisition administration system for medical and nursing application according to claim 1, wherein said automatic material supply machine further includes a second RFID recognition unit arranged in said material storage and electrically connected with said central control module, and wherein said second RFID recognition unit reads said material information of all said materials stored in said material storage and transmits said material information to said cloud platform, and said cloud platform undertakes statistics and administration of said materials.

12. The automatic stock and requisition administration system for medical and nursing application according to claim 1, wherein said automatic material supply machine further includes a display screen for presenting material stocks, material usage states, and results of user recognition.

13. The automatic stock and requisition administration system for medical and nursing application according to claim 1, wherein according to information of some said materials whose stocks are lower than preset standards, said cloud platform automatically generates at least one replenishment list to at least one material administrator supplying said materials.

14. An automatic stock and requisition administration method for medical and nursing application, comprising steps:
after an automatic material supply machine is turned on, said automatic material supply machine linking to a cloud platform through a network, and starting an initiation process;
said automatic material supply machine transmitting machine information thereof to said cloud platform;
said cloud platform providing said automatic material supply machine with at least one requisition form and user information of at least one user corresponding to said requisition form;
said user using at least one intelligent handheld device to link to and log in said cloud platform through a network to receive said requisition form;
undertaking a user recognition process to determine whether said user, who intends to pick at least one material, matches said user information; if not matching, waiting for a next user recognition request; if matching, undertaking a next step;
said user picking at least one said material listed in said requisition form from said automatic material supply machine; and
said automatic material supply machine reading material information of said material picked by said user to said cloud platform; said cloud platform recording said material information and updating stock information.

15. The automatic stock and requisition administration method for medical and nursing application according to claim 14 further comprising steps:
said automatic material supply machine linking to said cloud platform;
acquiring a protocol address of said cloud platform;
said automatic material supply machine linking to said protocol address; and
transmitting a machine information of said automatic material supply machine to said cloud platform.

16. The automatic stock and requisition administration method for medical and nursing application according to claim 14, wherein before said user picking at least one said material, said automatic material supply machine synchronizes with said cloud platform periodically.

17. The automatic stock and requisition administration method for medical and nursing application according to claim 14, wherein said machine information of said automatic material supply machine includes a model number of said automatic material supply machine, stocks of all types of said materials, and material information of said materials.

18. The automatic stock and requisition administration method for medical and nursing application according to claim 14, wherein said user recognition process is undertaken by a user recognition unit of said automatic material supply machine.

19. The automatic stock and requisition administration method for medical and nursing application according to claim 18, wherein in said user recognition process, said user uses said intelligent handheld device to present a QR (Quick Response) code to said user recognition unit or input a PIN (Personal Identification Number) code into said user recognition unit, and said user recognition unit verifies whether said user matches said user information.

20. The automatic stock and requisition administration method for medical and nursing application according to claim 14, wherein in said user recognition process, said user uses said intelligent handheld device to link to and log in said cloud platform; said cloud platform verifies whether said user using said intelligent handheld device to log in said cloud platform matches one piece of said user information; if matching, said cloud platform transmits said requisition form to said intelligent handheld device; after said cloud platform receives a requisition request message from said user, said cloud platform transmits a PIN code or QR code to said intelligent handheld device.

21. The automatic stock and requisition administration method for medical and nursing application according to claim 14, wherein before said cloud platform provides said automatic material supply machine with said requisition form, said user uses said intelligent handheld device or a computer to transmit a material requirement list to said cloud platform through a network; according to said material requirement list, said cloud platform generates said material requisition form and said user information corresponding to said user.

22. The automatic stock and requisition administration method for medical and nursing application according to claim 14 further comprising a step of presenting said material information, wherein said user uses said intelligent handheld device or a computer to edit said requisition form to form an amended requisition form and transmit said amended requisition information to said cloud information; after said cloud platform confirms said amended requisition form, said cloud platform generates a new requisition form and user information of said user, transmits said new requisition form and said user information of said user to said automatic material supply machine, and presents said new requisition form on said intelligent handheld device or said computer.

23. The automatic stock and requisition administration method for medical and nursing application according to claim 14, wherein in said step of said cloud platform providing said automatic material supply machine with at least one requisition form, said cloud platform automatically generates said requisition form according to a nursing requirement or a physician order; said cloud platform provides said requisition form according to a nursing schedule in said user information of said user.

24. The automatic stock and requisition administration method for medical and nursing application according to claim 14, wherein in said step of said cloud platform providing said automatic material supply machine with at least one requisition form, said requisition form is includes information of a carereceiver and at least one material required by said carereceiver.

25. The automatic stock and requisition administration method for medical and nursing application according to claim 14, wherein in said step of said cloud platform recording said material information, a first RFID (Radio Frequency IDentification) recognition unit of said automatic material supply machine reads said material information of said material picked by said user and transmits said material information of said material picked by said user to said cloud platform, and said cloud platform records said material information of said material picked by said user.

26. The automatic stock and requisition administration method for medical and nursing application according to claim 14, wherein in said step of said cloud platform recording said material information, a second RFID recognition unit of said automatic material supply machine reads said material information of said materials stored in a material storage and transmits said material information of said materials stored in a material storage to said cloud platform; then, said cloud platform undertakes statistics and administration of said materials.
